(19) United States
(12) Patent Application Publication
(10) Pub. No.: US 2003/0169844 A1
(43) Pub. Date: Sep. 11, 2003

(54) X-ray monochromator and x-ray fluorescence spectrometer using the same

(76) Inventors: Makoto Doi, Osaka (JP); Takashi Yamada, Osaka (JP)

Correspondence Address: BIRCH STEWART KOLASCH & BIRCH, PO BOX 747, FALLS CHURCH, VA, 22040-0747, US

(21) Appl. No.: 10/357,409

(22) Filed: Feb. 4, 2003

(30) Foreign Application Priority Data
Mar. 5, 2002 (JP) 2002-058660

(51) Int. Cl. G21K 1/06

(52) U.S. Cl. 378/84

(57) ABSTRACT

To provide an X-ray monochromator capable of sufficiently removing the harmful X-rays while the intensity of the main reflected line can be sufficiently maintained, an X-ray monochromator 4 is formed by depositing a plurality of layer pairs on a substrate 4c and each being made up of a reflecting layer 4a and a spacer layer 4b, with first and second multilayered films 4e1 and 4e2 including one or a plurality of layer pairs having a predetermined periodic length d, wherein so that of X-rays reflected from the first multilayered film 4e1 adjacent the substrate 4c, the X-rays of a desired energy can be removed by interference with X-rays reflected by the second multilayered film 4e2 remote from the substrate 4c, the predetermined periodic length d2, the material for the reflecting layers 4a or the material for the spacer layers 4b in the second multilayered film 4e2 are different from those in the first multilayered film 4e1 and, also, the second multilayered film 4e2 has a properly chosen number of the layer pairs.

### BACKGROUND OF THE INVENTION

1. Field of the Invention

The present invention relates to an X-ray monochromator is formed by depositing a plurality of layer pairs on a substrate and each being made up of a reflecting layer and a spacer layer, and also to an X-ray fluorescence spectrometer for

irradiating a sample with primary X-rays having been monochromated by the X-ray monochromator as defined in claim 1

2. Description of the Prior Art

In detection of a minute quantity of deposits on a sample such as, for example, a silicon wafer by means of a total reflection X-ray fluorescence analysis in which primary X-rays are emitted towards the sample at a minute angle of incidence, the primary X-rays to be emitted towards the sample have to be properly monochromated with a high integrated intensity so that the sample when so excited can emit a sufficiently high intensity of fluorescent X-rays with suppressing background noises. In such case, it is often practiced that X-rays emitted from an X-ray tube of a type utilizing tungsten (W) as a target are monochromated by a multilayered X-ray monochromator of W/B₄C (reflecting layer: tungsten/spacer layer: boron carbide) to provide monochromated W-Lβ line (9,670 eV) that can be used as the primary X-rays.

However, with the W/B₄C-based X-ray monochromator, the X-rays are not sufficiently monochromated (with a low resolution) and, accordingly, the primary X-rays tend to contain W-Lα line (8,396 eV) that is an interfering line with the analysis, resulting in failure to accomplish a sufficiently accurate analysis. If two X-ray monochromators are used in order to increase the resolution, and if the X-rays which have been monochromated by the first X-ray monochromator are again monochromated by the second X-ray monochromator, the intensity of W-Lβ line (main reflected line) obtained by monochromating will attenuate considerably. Thus, the problem associated with difficulty in removing the harmful X-rays sufficiently while the intensity of main reflected line is sufficiently maintained is inherent in the conventional X-ray monochromator of a kind utilizing the multilayered films regardless of whether it is used in X-ray fluorescence analysis for monochromating the primary X-rays.

### SUMMARY OF THE INVENTION

Accordingly, the present invention has been devised to substantially alleviate the foregoing problem and is intended to provide an X-ray monochromator capable of sufficiently removing the harmful X-rays while the intensity of the main reflected line can be sufficiently maintained, and also to provide an X-ray fluorescence spectrometer for irradiating a sample with the primary X-rays which have been monochromated by such X-ray monochromator.

In order to accomplish the foregoing objects of the present invention, there is, in accordance with one aspect of the present invention, provided an X-ray monochromator is formed by depositing a plurality of layer pairs on a substrate and each being made up of a reflecting layer and a spacer layer, with first and second multilayered films including one or a plurality of layer pairs having a predetermined periodic length, wherein so that of X-rays reflected from the first multilayered film adjacent the substrate, the X-rays of a desired energy can be removed by interference with X-rays reflected by the second multilayered film remote from the substrate, the predetermined periodic length, the material for the reflecting layers or the material for the spacer layers in the second multilayered film are different from those in the first multilayered film and, also, the second multilayered film has a properly chosen number of the layer pairs.

With the X-ray monochromator of the structure according to the present invention, since the second multilayered film having a properly different reflection characteristic is deposited on the first multilayered film, which strongly reflects the main reflected line, the X-rays of the particular energy can be considerably attenuated to diminish by the effect of interference of reflected X-rays at the first and second multilayered films. Moreover, since the entirety is the single X-ray monochromator and no monochromatization take place two times such as observed with the conventional technique in which the two identical X-ray monochromators are used, the intensity of the main reflected line will not be attenuated so considerably. Accordingly, it is possible to sufficiently remove the harmful X-rays, while the intensity of the main reflected line is sufficiently maintained. For ease to fabricate the X-ray monochromator of the present invention, it is preferred that the material for the reflecting layer in the second multilayered film and the material for the spacer layer in the second multilayered film are chosen to be the same as those in the first multilayered film. Also, the X-ray monochromator of the present invention can be suitably used in X-ray fluorescence analysis for monochromating the X-rays emitted from the X-ray source to provide the primary X-rays that can be used for irradiating the sample.

The present invention in accordance with another aspect thereof also provides an X-ray fluorescence spectrometer including an X-ray irradiating unit for irradiating a sample with primary X-rays, which have been monochromated by the X-ray monochromator of the present invention, and a detecting unit for measuring an intensity of fluorescent X-rays emitted from the sample. Even this X-ray fluorescence spectrometer can bring about effects similar to those brought about by the X-ray monochromator discussed above.

### BRIEF DESCRIPTION OF THE DRAWINGS

In any event, the present invention will become more clearly understood from the following description of preferred embodiments thereof, when taken in conjunction with the accompanying drawings. However, the embodiment and the drawings are given only for the purpose of illustration and explanation, and are not to be taken as limiting the scope of the present invention in any way whatsoever, which scope is to be determined by the appended claims. In the accompanying drawings, like reference numerals are used to denote like parts throughout the several views, and:

FIG. 1 is a schematic diagram showing an X-ray monochromator according to first and second preferred embodiments of the present invention;

FIG. 2 is a schematic diagram showing a total reflection X-ray fluorescence spectrometer according to a preferred embodiment of the present invention, in which the X-ray monochromator shown in FIG. 1 is employed;

FIG. 3 is a chart showing results of comparison of the calculated reflectivity exhibited by the X-ray monochromator of the present invention, in which the number N₂ of layer pairs in the second multilayered film is chosen to be 2, and that of the conventional X-ray monochromator, when continuous X-rays are monochromated;

FIG. 4 is a chart showing results of comparison of the calculated reflectivity exhibited by the X-ray monochromator of the present invention, in which the number N₂ of layer pairs in the second multilayered film is chosen to be 3, and that of the conventional X-ray monochromator, when continuous X-rays are monochromated;

FIG. 5 is a chart showing results of comparison of the calculated reflectivity exhibited by the X-ray monochromator of the present invention, in which the number N₂ of layer pairs in the second multilayered film is chosen to be 4, and that of the conventional X-ray monochromator, when continuous X-rays are monochromated;

FIG. 6 is a chart showing results of comparison of the calculated reflectivity exhibited by the X-ray monochromator of the present invention, in which the number N₂ of layer pairs in the second multilayered film is chosen to be 5, and that of the conventional X-ray monochromator, when continuous X-rays are monochromated;

FIG. 7 is a chart showing results of comparison of the calculated reflectivity exhibited by the X-ray monochromator of the present invention, in which the number N₂ of layer pairs in the second multilayered film is chosen to be 6, and that of the conventional X-ray monochromator, when continuous X-rays are monochromated;

FIG. 8 is a chart showing results of the calculated energy position of the X-rays that can be cut by the X-ray monochromator of the present invention, when while the number N₂ of layer pairs in the second multilayered film is fixed at 2 the periodic length d2 of the second multilayered film is varied relative to the periodic length d1 of the first multilayered film;

FIG. 9 is a chart showing results of the calculated ratio of the reflection intensity of W-Lβ line relative to that of W-Lα line in the X-ray monochromator of the present invention, when while the periodic length is fixed at 16.8 Å the number N₁ of layer pairs of the first multilayered film is varied;

FIG. 10 is a chart showing the relation between the ratio of the measured intensity of W-Lα line relative to that of W-Lβ line and the angle of incidence of the primary X-rays monochromated by the X-ray monochromator according to the first embodiment of the present invention and the conventional X-ray monochromator;

FIG. 11 is a chart showing results of the calculated reflectivity exhibited by the X-ray monochromator of the present invention of a structure different from FIGS. 3 to 7, in which the number N₂ of layer pairs in the second multilayered film is chosen to be 1, and that of the conventional X-ray monochromator, when continuous X-rays are monochromated;

FIG. 12 is a chart showing results of the calculated reflectivity exhibited by the X-ray monochromator of the present invention of a structure different from FIGS. 3 to 7, in which the number N₂ of layer pairs in the second multilayered film is chosen to be 2, and that of the conventional X-ray monochromator, when continuous X-rays are monochromated;

FIG. 13 is a chart showing results of the calculated reflectivity exhibited by the X-ray monochromator of the present invention of a structure different from FIGS. 3 to 7, in which the number N₂ of layer pairs in the second multilayered film is chosen to be 3, and that of the conventional X-ray monochromator, when continuous X-rays are monochromated;

FIG. 14 is a chart showing results of the calculated reflectivity exhibited by the X-ray monochromator of the present invention of a structure different from FIGS. 3 to 7, in which the number N₂ of layer pairs in the second multilayered film is chosen to be 4, and that of the conventional X-ray monochromator, when continuous X-rays are monochromated;

FIG. 15 is a chart showing results of the calculated reflectivity exhibited by the X-ray monochromator of the present invention of a structure different from FIGS. 3 to 7, in which the number N₂ of layer pairs in the second multilayered film is chosen to be 5, and that of the conventional X-ray monochromator, when continuous X-rays are monochromated; and

FIG. 16 is a chart showing results of the calculated reflectivity exhibited by the X-ray monochromator of the present invention of a structure different from FIGS. 3 to 7, in which the number N₂ of layer pairs in the second multilayered film is chosen to be 6, and that of the conventional X-ray monochromator, when continuous X-rays are monochromated;

### DETAILED DESCRIPTION OF THE EMBODIMENT

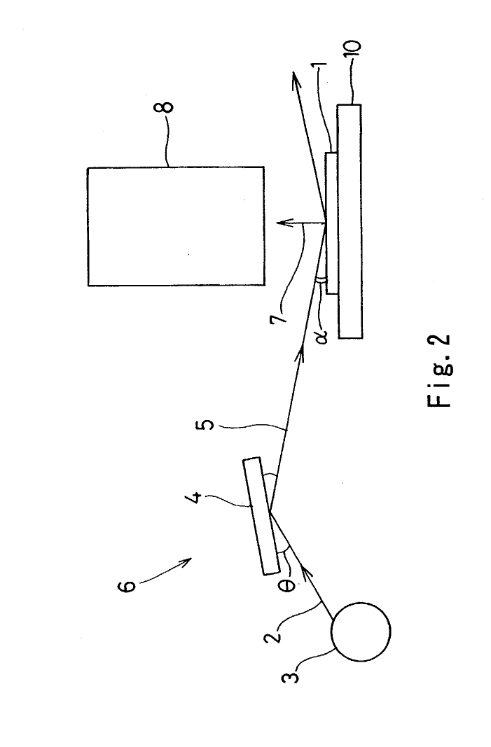

Hereinafter, an X-ray fluorescence spectrometer according to a preferred embodiment of the present invention will be described with reference to the accompanying drawings. As shown in FIG. 2, the X-ray fluorescence spectrometer is in the form of a total reflection X-ray fluorescent spectrometer of a design in which primary X-rays 5 from a X-ray source 3 are emitted towards a surface of a sample 1 at a minute incident angle α which, although shown as exaggerated, may be, for example, about 0.1 degree. This X-ray fluorescence spectrometer includes an X-ray irradiating unit 6 for irradiating the sample 1 such as, for example, a Si wafer placed on a sample support 10, with the primary X-rays 5 which have been monochromated by an X-ray monochromator 4, and a SSD 8 which is a detecting unit for measuring the intensity of fluorescent X-rays 7 emitted from the sample 1 when the latter is excited in response to the primary X-rays. It is, however, to be noted that the X-ray fluorescence spectrometer to which the present invention can be applied is not always limited to the total reflection X-ray fluorescence spectrometer. The X-ray irradiating unit 6 includes the X-ray source 3 capable of emitting X-rays containing W-Lβ line as characteristic X-rays, that is, an X-ray tube 3 capable of emitting X-rays 2 from a tungsten target so far shown, and the X-ray monochromator 4 for monochromating the X-rays 2 emitted from the X-ray tube 3.

The X-ray monochromator 4 itself constitutes a preferred embodiment of the present invention and, although the X-ray monochromator of the present invention can be utilized in numerous applications and/or can have numerous structures, only two representative applications and structures will be described hereinafter as the X-ray monochromators according to the first and second preferred embodiments of the present invention, respectively.

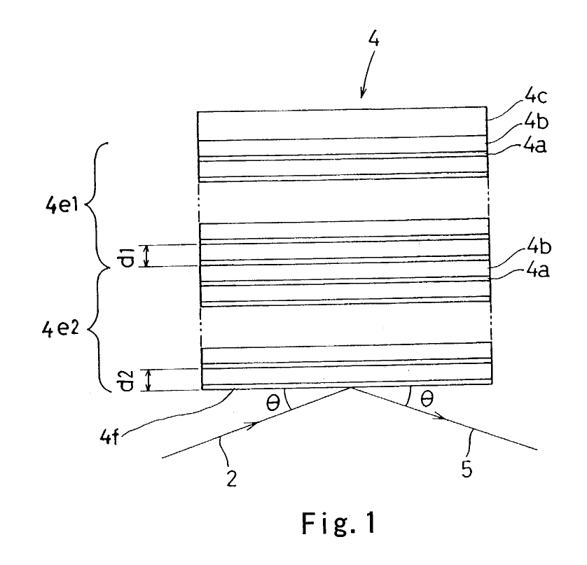

The X-ray monochromator 4 according to the first embodiment is used in X-ray fluorescence analysis for monochromating the X-rays 2, emitted from the X-ray tube 3, to provide the primary X-rays 5 of W-Lβ line that are subsequently emitted towards the sample 1. As shown in FIG. 1, this X-ray monochromator 4

is formed by depositing a plurality of layer pairs on a substrate 4c and each being made up of a reflecting layer 4a and a spacer layer 4b, wherein there is provided two multilayered films 4e including a plurality of layer pairs having a predetermined periodic length d. The first multilayered film 4e1 held in direct contact with the substrate 4c is of a structure in which the periodic length d1, which is the thickness of the layer pair 4a and 4b, and the angle θ of incidence (so far as this angle θ of incidence is concerned, it is the same as that in the second multilayered film 4e2) are so chosen that W-Lβ line can undergo Bragg reflection. So that of the X-rays reflected from the first multilayered film 4e1, W-Lα line that will serve as an interfering line with the analysis can be removed by interference with X-rays reflected from the second multilayered film 4e2 positioned on one side of the first multilayered film 4e1 remote from the substrate 4c and adjacent to an incident surface 4f, not only does the second multilayered film 4e2 have the predetermined periodic length d2 that is different from the periodic length d1 in the first multilayered film 4e1, but the number of layer pairs used in the second multilayered film 4e2 is properly chosen.

In this illustrated embodiment, for ease to fabricate the X-ray monochromator 4, the reflecting and spacer layers 4a and 4b in the second multilayered film 4e2 are made of the same materials as that in the first multilayered film 4e1, with the reflecting and spacer layers 4a and 4b made of tungsten (W) and boron carbide, respectively. However, the present invention is not always limited to the use of these particular materials. Also, the ratio of layer thickness between the reflecting and spacer layers 4a and 4b may not be always limited to a particular value. As regards the shape, while the X-ray monochromator 4 is shown as a flat plate configuration, it may be curved. Where the X-ray monochromator is curved in shape, it is well known in the art to vary the periodic length d in the direction along the curvature thereof so that in one multilayered film (i.e., the multilayered film having a constant periodic length in a direction of depth thereof and in which each material for the layer pair is fixed in a direction of depth thereof) the X-rays of the same energy can be reflected from different portions of the X-ray monochromator in the direction of curvature, and this known technique can be applied to the present invention.

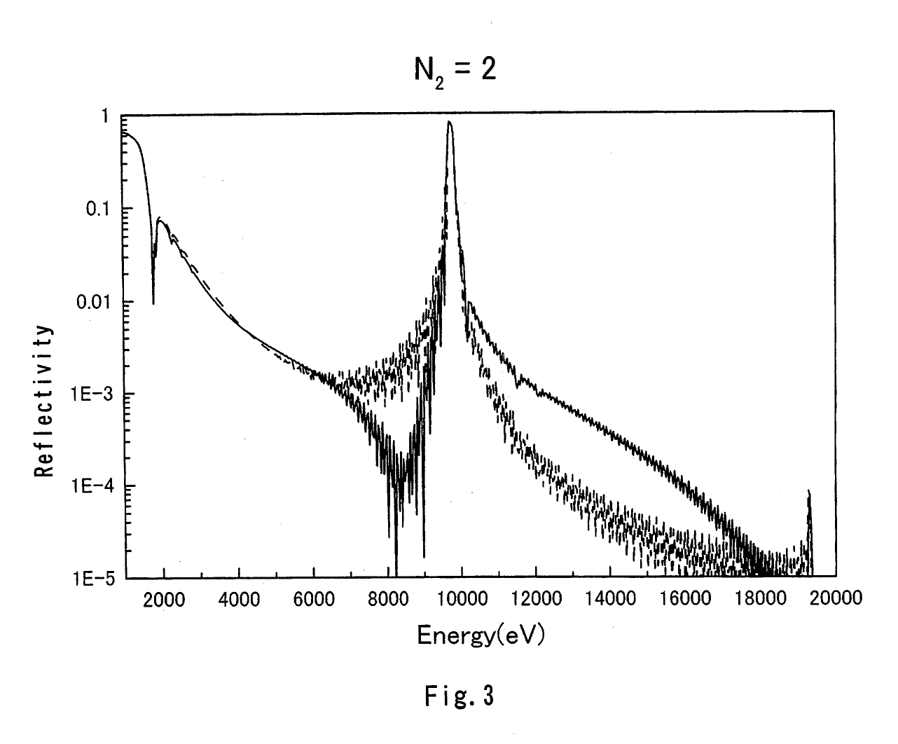

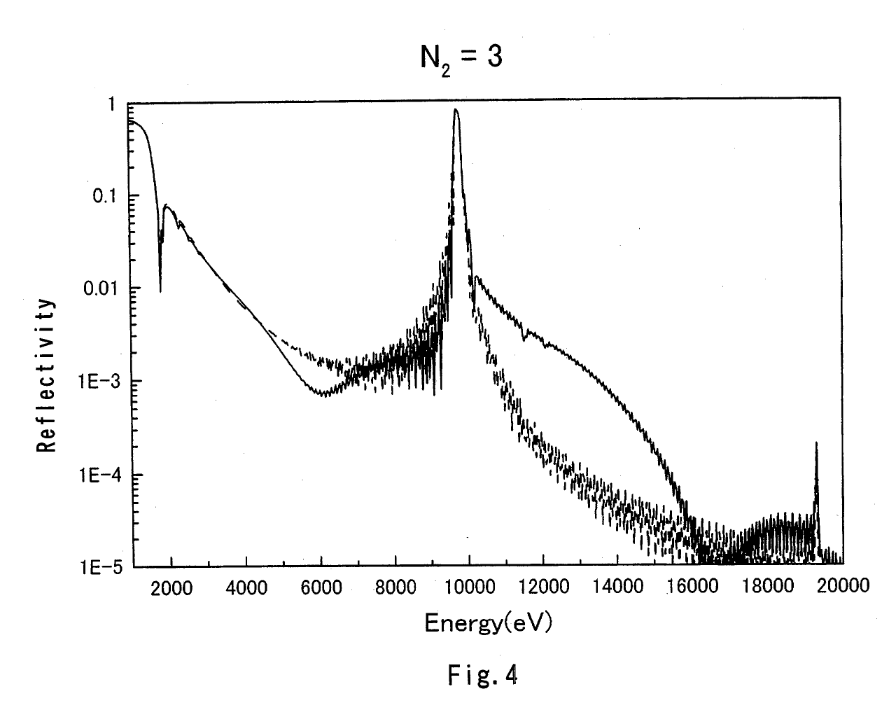

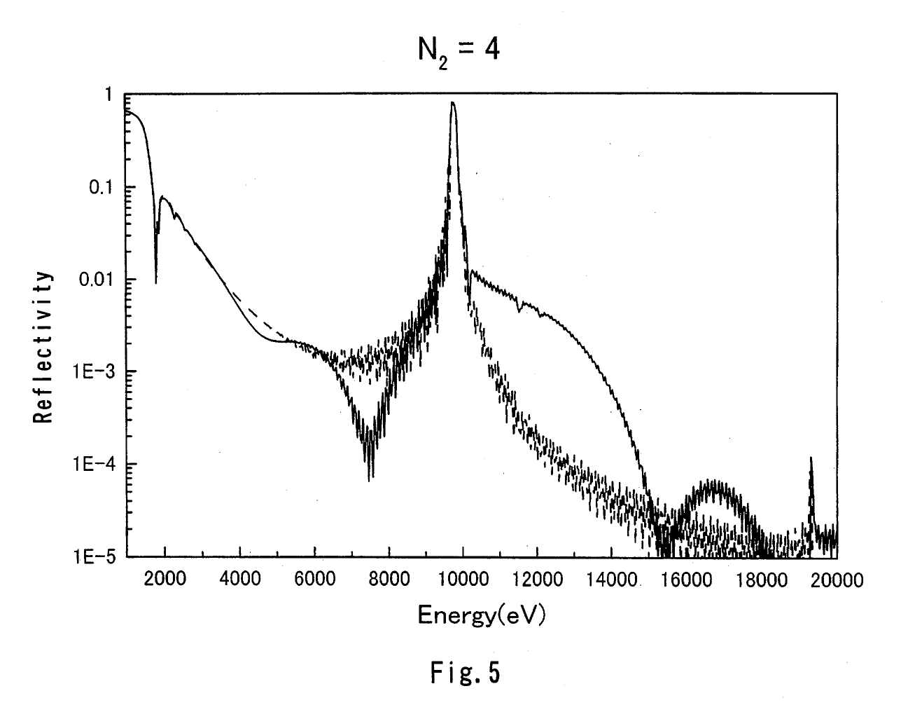

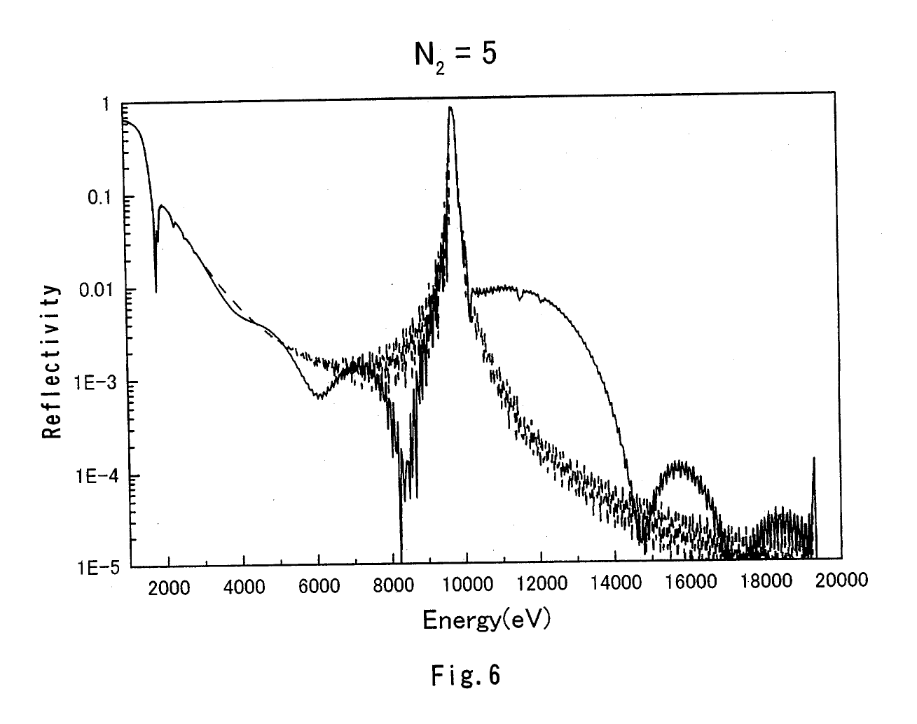

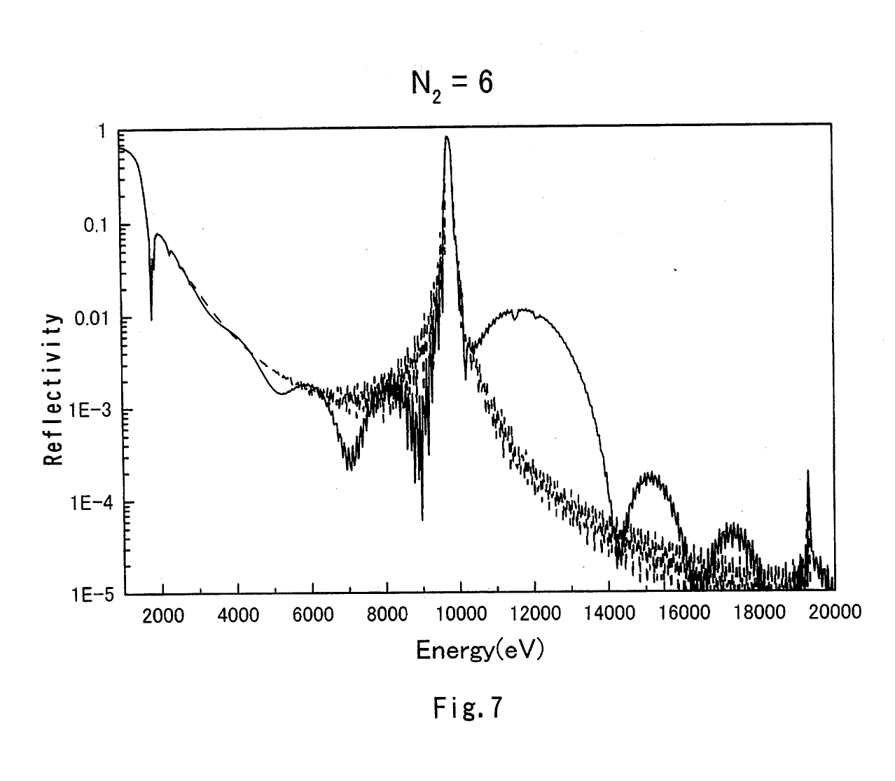

With respect to the X-ray monochromator utilizing the W/B₄C multilayered films on the silicon substrate, results comparison of simulated calculation of the reflectivity, exhibited by the X-ray monochromators of the present invention in which the number N₂ of the multilayered films is within the range of 2 to 6, with that exhibited by the conventional X-ray monochromator having a single multilayered film, when by both X-ray monochromators continuous X-rays of 1,000 to 20,000 eV are monochromated, are shown in the respective charts of FIGS. 3 to 7. In these charts, solid lines represent the reflectivity exhibited by each of the X-ray monochromators according to the present invention while broken lines represent that exhibited by the conventional X-ray monochromator. Here, in order that W-Lβ line can undergo the Bragg reflection, the first multilayered film is made up of 150 laminations of the layer pair having a periodic length of 21 Å and the angle of incidence on the X-ray monochromator is chosen to be 1.76 degree in both cases. On the other hand, the second multilayered film was chosen to have a periodic length of 16.8 Å that is 0.8 times the periodic length of the first multilayered film (21 Å).

According to the present invention, even though the number N₂ of the layer pairs used in the second multilayered film is any value within the range of 2 to 6, the reflectivity of W-Lβ line (9,670 eV) that is the main reflected line in the illustrated embodiment can be maintained at a value about equal to that exhibited by the conventional X-ray monochromator, but it will readily be seen that if N₂ is chosen to be 2, the reflectivity in the vicinity of W-Lα line (8,396 eV) that is an interfering line in the illustrated embodiment is considerably reduced as compared with that in the conventional X-ray monochromator. Accordingly, the number N₂ of the layer pairs used in the second multilayered film in the X-ray monochromator according to the first embodiment is suitably chosen to be 2.

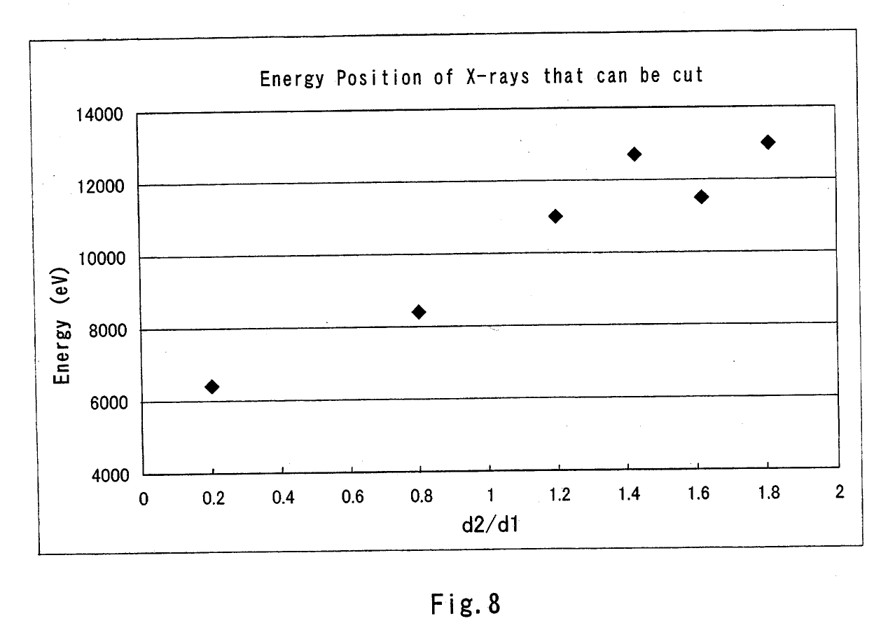

In view of the above, results of simulated calculation performed in a manner similar to that shown in FIGS. 3 to 7 with respect to the energy position at which the reflectivity can be reduced down to a value lower than that exhibited by the conventional X-ray monochromator when, while the number N₂ of the layer pairs in the second multilayered film is fixed at 2, the periodic length d2 of the second multilayered film is varied relative to the periodic length d1=21 Å in the first multilayered film, that is, with respect to the position of the X-ray energy that can be cut, are shown in FIG. 8. According to the chart of FIG. 8, it will readily be seen that when the periodic length d2 in the second multilayered film is chosen to be 16.8 Å which is 0.8 times the periodic length of 21 Å in the first multilayered film, W-La line (8,396 eV) that will serves as an interfering line in this embodiment can be cut off. Accordingly, for the periodic length d2 in the multilayered film 4e2 of the X-ray monochromator according to the first embodiment, 16.8 A appears to be appropriate.

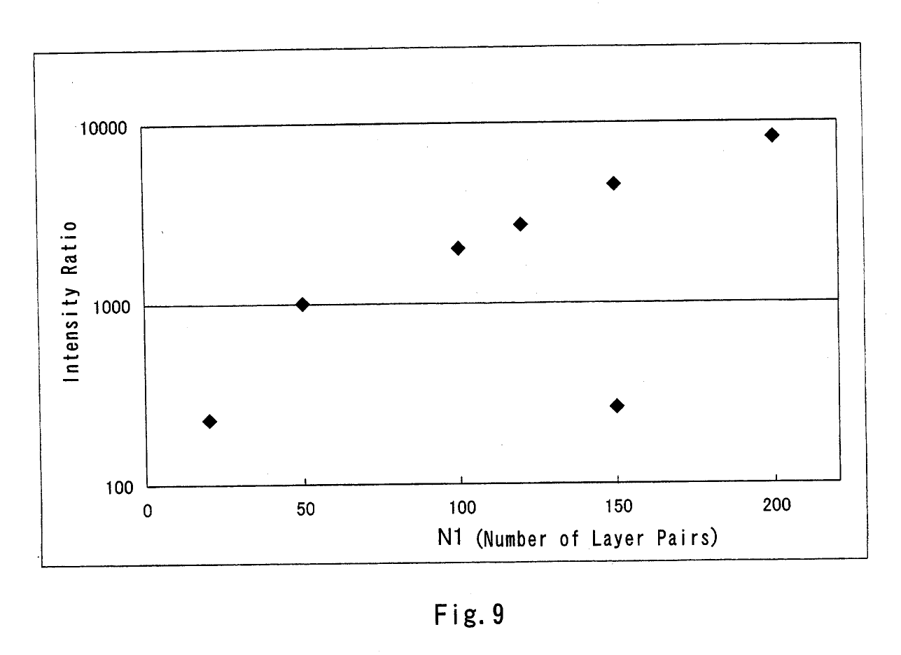

Also, the ratio of the intensity of reflection of W-Lβ line relative to the intensity of reflection of W-Lα line when the number N₁ of the layer pairs in the first multilayered film while the number N₂ of the layer pairs in the second multilayered film and the periodic length d2 thereof are chosen to be 2 and 16.8 Å, respectively, is determined by a similar simulated calculation, results of which are shown in FIG. 9. It is to be noted that a lower plot shown at the number of the layer pairs reading 150 represents a value exhibited by an X-ray monochromator having no second multilayered film, that is, the conventional X-ray monochromator. Thus, according to the chart shown in FIG. 9, the number N₁ of the layer pairs in the first multilayered film 4e1 of the X-ray monochromator 4 according to the first embodiment is preferably not smaller than 50 and appears to be sufficient with 150 so that the intensity ratio can be of a value sufficiently greater than the conventional value.

Based on the foregoing results of study, for the X-ray monochromator 2 according to the first embodiment, the W/B₄C-based X-ray monochromator was fabricated, in which the first multilayered film 4e1 has a periodic length d1 of 21 Å, with the number N₁ of the layer pairs being 150 and the second multilayered film 4e2 has a periodic length d2 of 16.8 Å with the number N₂ of the layer pairs being 2. On the other hand, for comparison purpose, the X-ray monochromator with no second multilayered film 4e2 employed was used as the conventional X-ray monochromator.

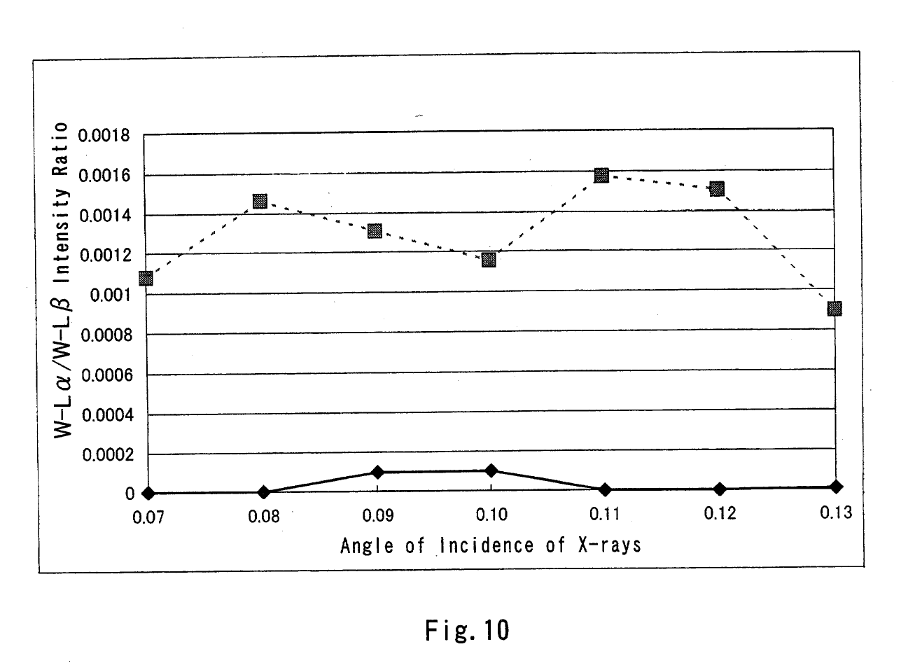

Using the total reflection X-ray fluorescence spectrometer of the structure shown in FIG. 2, the X-rays 2 emitted from the X-ray tube 3 having the tungsten target were monochromated by each of the X-ray monochromators and, using the monochromated W-Lβ line as the primary X-rays 5, the intensities of W-Lα line 7 and W-Lα line 7 emitted from the sample 1, which is a silicon wafer, were measured with the SSD8 by irradiating the sample 1 with the primary X-rays 5 at a varying angle α of incidence. The relationship between the ratio of the measured intensity of W-Lα line relative to that of W-Lβ line exhibited by each of the X-ray monochromators and the angle α of incidence is shown in FIG. 10. In this chart of FIG. 10, solid lines represent the intensity ratio exhibited by the X-ray monochromator according to the first embodiment of the present invention whereas dotted lines represent the intensity ratio exhibited by the conventional X-ray monochromator. Zero intensity ratio means that no peak was observed in W-Lα line. According to the chart of FIG. 10, it will readily be seen that with the X-ray monochromator 4 according to the first embodiment, the ratio of the intensity of the interfering line, that is, W-Lα line, relative to that of the main reflected line, that is, W-Lβ line is lowered by a factor of 10 or more and, hence, the interfering line is substantially diminished, that is, removed effectively.

As hereinabove fully described, since in the X-ray monochromator according to the first embodiment the second multilayered film 4e2 having a properly different reflection characteristic is provided on the first multilayered film 4e1 effective to strongly reflect W-Lβ line that is the main reflected line, W-Lα line, that will be the interfering line, can be considerably attenuated to diminish by the effect of interference of reflected X-rays at the first and second multilayered films 4e1 and 4e2. Moreover, since the entirety is the single X-ray monochromator 4 and no monochromatization take place two times such as observed with the conventional technique in which the two identical X-ray monochromators are used, the intensity of W-Lβ line that is the main reflected line will not be attenuated so considerably. Accordingly, it is possible to sufficiently remove W-Lα line, that will be the interfering line, while the intensity of W-Lβ line, that is the main reflected line, is sufficiently maintained. The X-ray fluorescence spectrometer according to the embodiment of FIG. 2 in which the primary X-rays having been monochromated by the X-ray monochromator of the first embodiment can bring about meritorious effects similar to those brought about by the X-ray monochromator of the first embodiment.

Hereinafter, the X-ray monochromator 4 according to the second preferred embodiment of the present invention will be described. Even the X-ray monochromator 4 is used in X-ray fluorescence analysis for monochromating the X-rays 2, emitted from the X-ray tube 3, to provide the primary X-rays 5 of W-Lβ line that are subsequently emitted towards the sample 1. As shown in FIG. 1, this X-ray monochromator 4 is formed by depositing a plurality of layer pairs on a substrate 4c and each being made up of a reflecting layer 4a and a spacer layer 4b, wherein there is provided two multilayered films 4e including a plurality of layer pairs having a predetermined periodic length d. The first multilayered film 4e1 held in direct contact with the substrate 4c is of a structure in which the periodic length d1, which is the thickness of the layer pair 4a and 4b, and the angle θ of incidence (so far as this angle θ of incidence is concerned, it is the same as that in the second multilayered film 4e2) are set to the same values as those in the X-ray monochromator according to the first embodiment, respectively, so that W-Lβ line can undergo Bragg reflection.

So that of the X-rays reflected from the first multilayered film 4e1, W-Lα line that will serve as an interfering line with the analysis can be removed by interference with X-rays reflected from the second multilayered film 4e2 positioned on one side of the first multilayered film 4e1 remote from the substrate 4c and adjacent to an incident surface 4f, not only is the reflecting layer 4a in the second multilayered film 4e2 made of nickel (Ni), which is different from tungsten used to form the reflecting layer 4a in the first multilayered film 4e1, but the number of the layer pairs in the second multilayered film 4e2 is also chosen. It is to be noted that the material for the spacer layer 4b employed in each of the multilayered films 4e1 and 4e2 of the X-ray monochromator 4 according to this second embodiment is boron carbide (B₄C). Also, the predetermined periodic length d2 in the second multilayered film 4e2 is the same as the periodic length d1 in the first multilayered film 4e1 and, hence, d2=d1=21 Å. Other structural features of the X-ray monochromator according to the second embodiment of the present invention are, except for the number N₂ of the layer pairs in the second multilayered film 4e2, similar to those of the X-ray monochromator according to the previously described first embodiment and, hence, the number N₁ of the layer pairs in the first multilayered film 4e1 is 150.

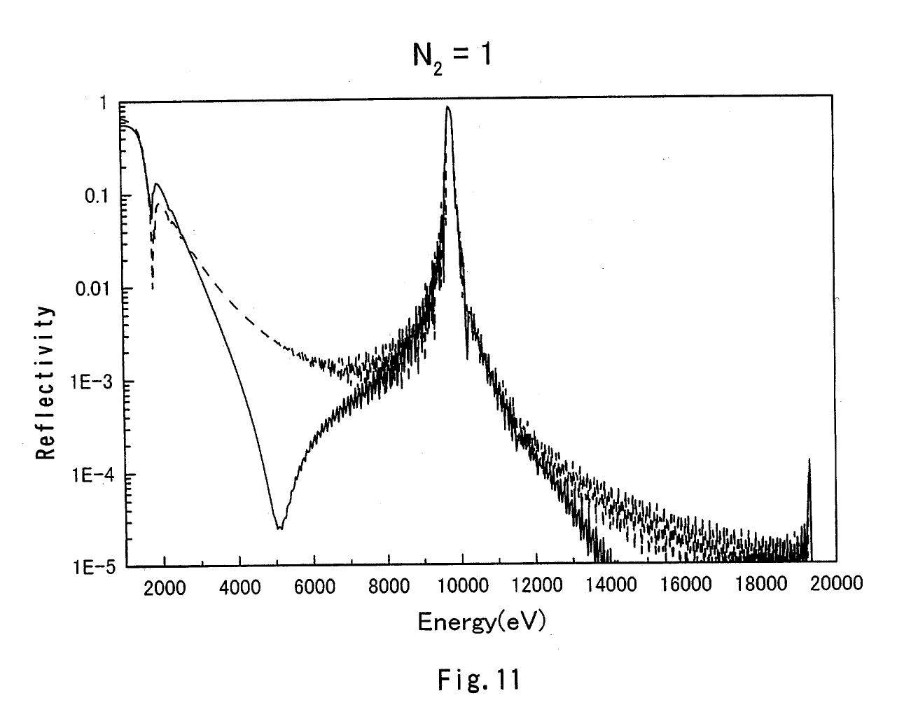

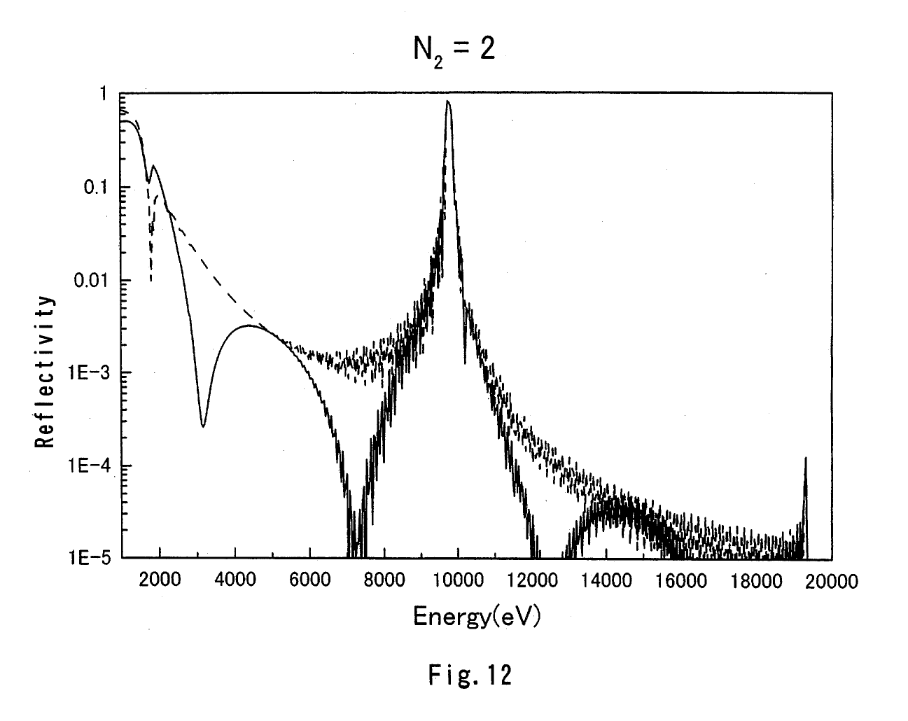

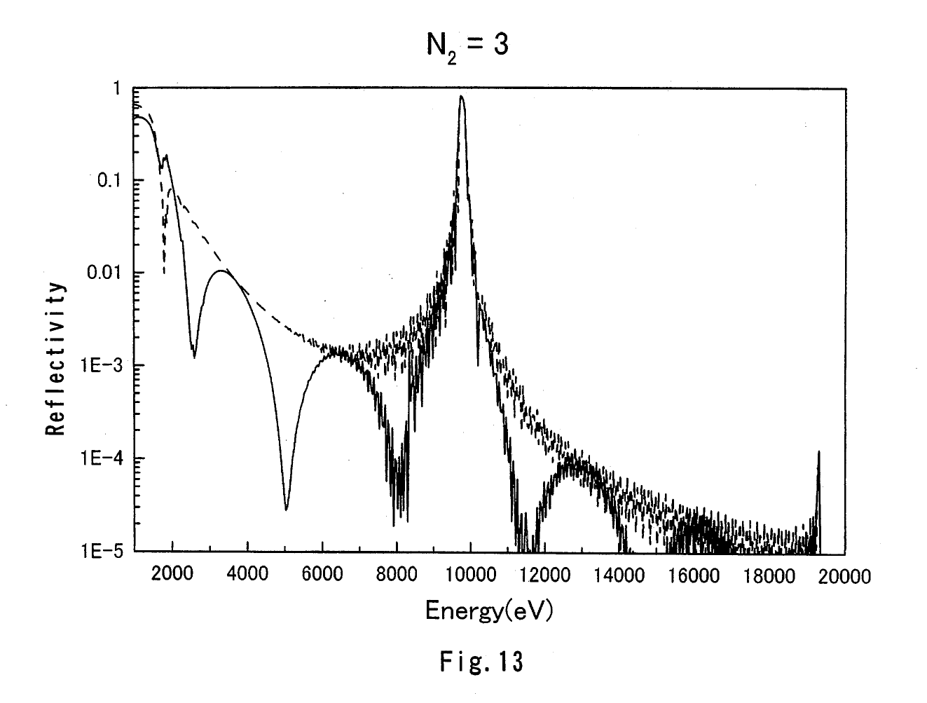

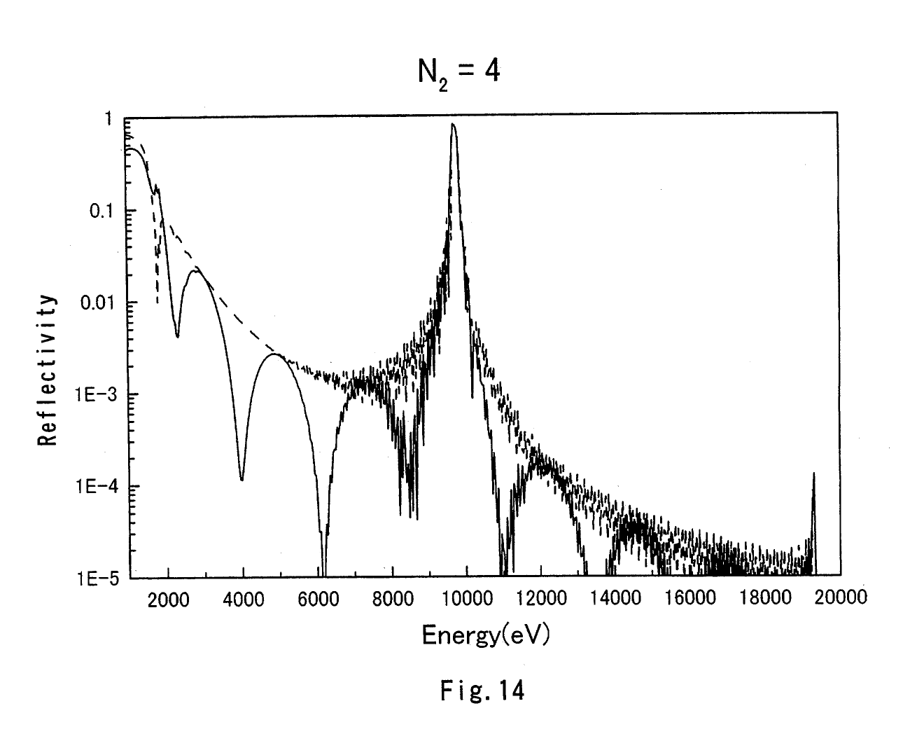

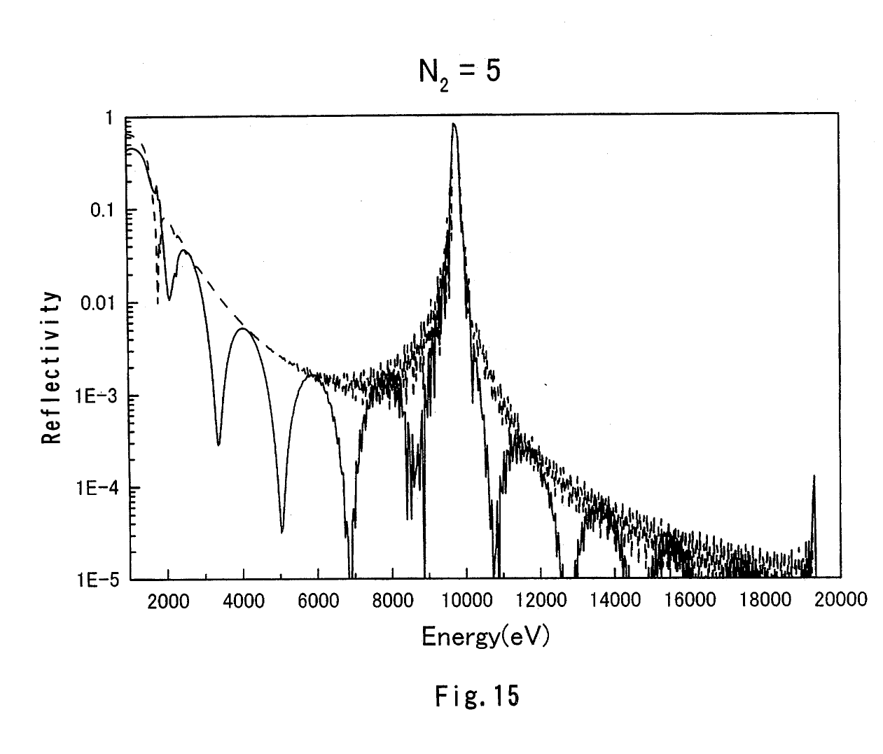

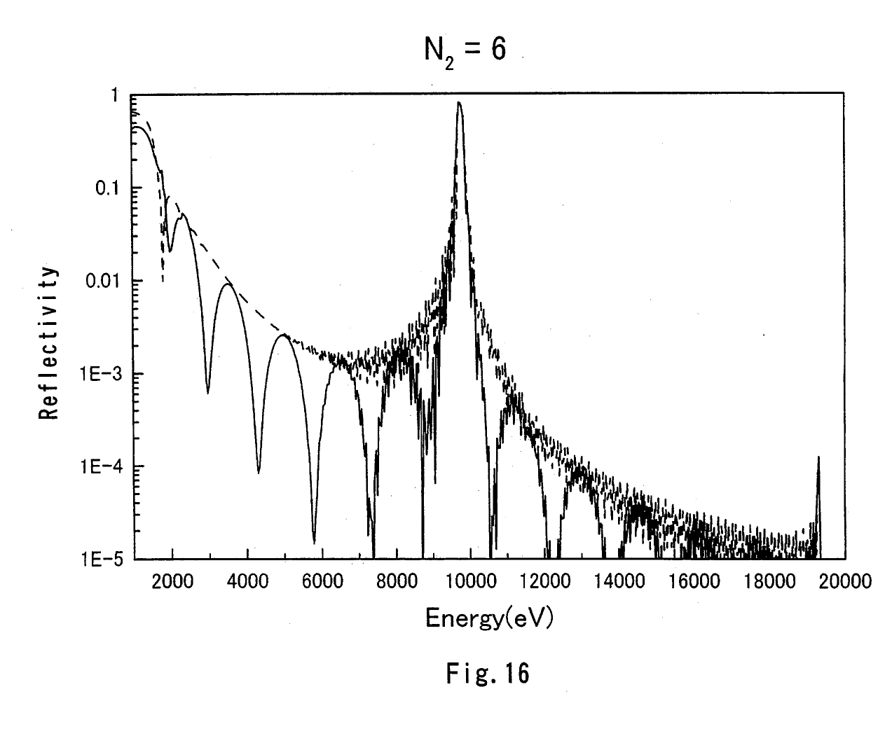

With the X-ray monochromator of the structure described above, using the X-ray monochromators of the present invention, in which the number N₂ of the layer pairs in the second multilayered film is chosen to be a value within the range of 1 to 6, and the conventional X-ray monochromator including only the first multilayered film, the respective reflectivity exhibited when continuous X-rays of 1,000 to 20,000 eV are monochromated, was calculated by simulation as is the case with FIGS. 3 to 7, results of which are shown in FIGS. 11 to 16. In these figures, the solid lines represent the reflectivity exhibited by the X-ray monochromators of the present invention whereas that exhibited by the conventional X-ray monochromator is shown by broken lines.

According to the charts shown in FIGS. 11 to 16, it will readily be seen that even though any value within the range of 1 to 6 is taken for the number N₂ of the layer pairs in the second multilayered film, the reflectivity of W-Lβ line (9,670 eV), that is the main reflected line in this second embodiment can be maintained at a value about equal to that in the conventional X-ray monochromator, but when N₂ is chosen to be 4, the reflectivity can be considerably reduced in the vicinity of W-Lα line (8,396 eV), that will be the interfacing line, as compared with that in the conventional X-ray monochromator. Accordingly, the number N2 of the layer pairs in the second multilayered film 4e2 in the X-ray monochromator 4 according to this second embodiment is preferably 4.

Since even in the X-ray monochromator 4 according to the second embodiment the first multilayered film 4e1, which strongly reflects W-Lβ line that is the main reflected line has deposited thereon the second multilayered film 4e2 having a properly different reflection characteristic, W-Lα line, that will be the interfering line, can be considerably attenuated to diminish by the effect of interference of reflected X-rays at the first and second multilayered films 4e 1 and 4e2. Moreover, since the entirety is the single X-ray monochromator 4 and no monochromatization take place two times such as observed with the conventional technique in which the two identical X-ray monochromators are used, the intensity of W-Lβ line that is the main reflected line will not be attenuated so considerably. Accordingly, it is possible to sufficiently remove W-Lα line, that will be the interfering line, while the intensity of W-Lβ line, that is the main reflected line, is sufficiently maintained.

As can be readily understood from comparison between the charts of FIGS. 3 to 7 associated with the X-ray monochromator in which the first and second multilayered films have the layer pairs made of the same material, but have the different periodic lengths (such as in the first embodiment), and the charts of FIGS. 11 to 16 associated with the X-ray monochromator in which the first and second multilayered films have the layer pairs made of the different materials, but have the same periodic lengths (such as in the second embodiment), there is no possibility in the X-ray monochromator according to the second embodiment that the resolution thereof will be reduced (i.e., the reflectivity will increase) as compared with the conventional X-ray monochromator at opposite side of the interfering line (W-Lα line) relative to the main reflected line (W-Lβ line), that is, a higher energy side than the main reflected line (W-Lβ line) in this embodiment. The X-ray fluorescence spectrometer according to the embodiment of FIG. 2 in which the primary X-rays having been monochromated by the X-ray monochromator of the second embodiment can bring about meritorious effects similar to those brought about by the X-ray monochromator of the second embodiment.

It is to be noted that in the practice of the present invention, when the material different from that for the layer pairs in the first multilayered film is employed for the layer pairs in the second multilayered film, the material for one of the reflecting and spacer layers may be different from that used in the first multilayered film or the materials for the reflecting and spacer layers may be different from the materials for the reflecting and spacer layers in the first multilayered film. Also, one of the materials for the layer pairs and the periodic lengths thereof may be different from that in the first multilayered film, or both of the materials for the layer pairs and the periodic lengths thereof may be different from those in the first multilayered film. In addition, the number of the layer pairs forming each of the first and second multilayered films may be single or plural.

Although the present invention has been fully described in connection with the preferred embodiment thereof with reference to the accompanying drawings which are used only for the purpose of illustration, those skilled in the art will readily conceive numerous changes and modifications within the framework of obviousness upon the reading of the specification herein presented of the present invention. Accordingly, such changes and modifications are, unless they depart from the scope of the present invention as delivered from the claims annexed hereto, to be construed as included therein.

What is claimed is:

1. An X-ray monochromator which comprises:
a plurality of layer pairs deposited on a substrate, each of the layer pairs being made up of a reflecting layer and a spacer layer; with
first and second multilayered films each including one or a plurality of layer pairs having a predetermined periodic length, said first multilayered film being positioned on the substrate side while the second multilayered film is positioned on an incident surface side;
wherein so that of X-rays reflected from the first multilayered film the X-rays of a desired energy can be removed by interference with X-rays reflected by the second multilayered film, the predetermined periodic length, the material for the reflecting layers or the material for the spacer layers in the second multilayered film are different from those in the first multilayered film and, also, the second multilayered film has a properly chosen number of the layer pairs.

2. The X-ray monochromator as claimed in claim 1, wherein the respective materials for the reflecting and spacer layers in the second multilayered film are the same as those in the first multilayered film.

3. The X-ray monochromator as claimed in claim 1, that is used in X-ray fluorescence analysis for monochromating X-rays emitted from an X-ray source to provide primary X-rays usable to irradiate a sample.

4. An X-ray fluorescence spectrometer which comprises:
an X-ray irradiating unit for irradiating a sample with primary X-rays, which have been monochromated by the X-ray monochromator as defined in claim 3; and
a detecting unit for measuring an intensity of fluorescent X-rays emitted from the sample.
